(19) United States
(12) Patent Application Publication
(10) Pub. No.: US 2019/0393721 A1
(43) Pub. Date: Dec. 26, 2019

(54) TRANSMISSION OF ELECTRICAL ENERGY BETWEEN USER ENTITIES OF A DISTRIBUTION NETWORK

(71) Applicant: ELECTRICITE DE FRANCE, Paris (FR)

(72) Inventors: Daniel Pignier, L'Hay Les Roses (FR); David Menga, Verrieres-le-Buisson (FR)

(21) Appl. No.: 16/471,285

(22) PCT Filed: Dec. 19, 2017
(86) PCT No.: PCT/EP2017/083522

§ 371 Date: Jun. 19, 2019

(30) Foreign Application Priority Data
Dec. 19, 2016 (FR) 16 62741

(51) Int. Cl. H02J 13/00; H02J 3/38; H02J 9/06; H02J 3/00; H02J 3/14

(52) U.S. Cl. CPC H02J 13/0003; H02J 3/382; H02J 9/062; H02J 13/0048; H02J 3/14; H02J 13/0024; H02J 3/008

(57) ABSTRACT

Delivery of an amount of electrical energy between an energy producing entity and an energy consuming entity. The amount of energy is delivered via an electricity distribution network in the form of at least one temporal flow of electric power, at a constant level on at least a main part of the flow. In particular, in order to identify the delivery via the network, the flow further comprises an additional part comprising delivery identification data, the electric power being modulated in amplitude in the additional part, the additional part therefore having periods when the electric power is lower than said constant level of the main part of the flow.

### CROSS-REFERENCE TO RELATED APPLICATIONS

This application is the U.S. national phase of the International Patent Application No. PCT/EP2017/083522 filed Dec. 19, 2017, which claims the benefit of French Application No. 16 62741 filed Dec. 19, 2016, the entire content of which is incorporated herein by reference.

### FIELD

This disclosure generally relates to the management of energy routing in an electricity distribution network.

### BACKGROUND

The electricity distribution network, whether in a neighborhood or inside a building, currently transmits alternating energy (AC) for which the origin and destination is not fully traceable today.

It is therefore not possible to certify that a customer who buys “green” energy (from solar, wind, or other renewable energy channels), at a given time T, is actually consuming such energy.

Moreover, the 2020 French thermal regulations require that new houses be equipped with means for producing local energy as well as a storage means, both of them using direct electrical energy (DC), in order to move towards a home that is energy-autonomous.

In addition, in this current digital era, older uses of electricity include electronic components that require converting alternating energy into direct energy in order to operate. This therefore involves widely distributed converters in order to supply power to light-emitting diode (LED) devices, devices such as computers, terminal battery chargers (telephones, tablets, etc.), and more generally all brown goods, and increasingly more and more white goods.

The electrical architecture for the production, distribution, and use of energy in the home must also take into account the multiple losses associated with energy conversion, must be able to provide AC power for existing equipment as well as DC power for new equipment or permit its direct use, providing secure energy according to the priorities, characteristics, availability, and traceability of energy at the lowest possible cost.

Moreover, in France, Ruling No. 2016-1019 of Jul. 27, 2016 concerning shared collective self-consumption of electricity requires that tools be put in place such as, for example, an energy exchange platform at the scale of a neighborhood and/or of a low voltage (LV) substation and/or of an outgoing line of an LV substation.

Today, there is indeed a market for offers to purchase “green” energy (from renewable energy sectors). However, the current that is consumed at any given time does not provide any information on its origin. There is of course the known “blockchain” technology as applied to energy, for validating the fact that a producer is contracted to provide a consumer with renewable energy. However, there is a lack of formal “labeling” of the current at the moment it is used that can guarantee a match between the current produced in one place and the current consumed in another. In any case, such a method could not typically be implemented to deliver alternating current using an associated conventional transmission of data.

A tool is therefore needed that is capable of listing the transactions between producers and consumers, and in particular is capable of tracking an amount of electrical energy received from a producing entity and intended for a consuming entity.

This disclosure can improve the situation.

### SUMMARY

To achieve this, it offers a method for delivering an amount of electrical energy between an energy producing entity and an energy consuming entity. This amount of energy is delivered via an electricity distribution network in the form of at least one temporal flow of electric power, at a constant level for at least the main part of the flow.

In particular, to identify the delivery via the network, the flow further comprises an additional part comprising delivery identification data. This additional part is where the electric power is modulated in amplitude, the additional part thus having periods when the electric power is lower than said constant level of the main part of the flow.

The term “electric power modulation” should be considered in the general sense and may include both direct power modulation, but also possibly voltage modulation (in direct current (DC), the effect of this is essentially to modulate the power).

Furthermore, the above phrase “via an electricity distribution network” is understood to mean using a local sub-network of the general electricity distribution network, typically such as the low voltage network, for example.

So, in one variant, as the amount of energy is delivered as direct current, said additional part of the flow comprises times when the voltage of the flow is zero. Modulation is applied to the voltage in order to encode the delivery identification data into two binary values corresponding to a zero voltage and a maximum voltage, the maximum voltage corresponding to the constant level of power of the main part of the flow.

In one particular variant, the energy delivery is carried out by a transmission of a plurality of successive packets of temporal flows, each comprising a main part of the flow and an additional part comprising delivery identification data, the additional part of the flow preceding the main part of the flow in each packet. It is further understood that the disclosure can be implemented in the case of delivering a single packet therefore comprising a single flow, if this single packet is sufficient to provide the amount of electrical energy required.

In the case of delivering multiple packets, these packets may be spaced apart in time by a chosen duration of synchronization of the distribution network, during which the power is zero. This synchronization duration may allow entities receiving the packets to start reading the packet header (the aforementioned additional part) in order to extract the data encoded therein.

The identification data may comprise, for example:
an identifier relating to the producing entity,
an identifier relating to the consuming entity,
an amount of energy to deliver.

The identification data may further include:
a type of electrical energy produced at least according to renewable energy production channels or according to other channels.

In addition, a timestamp may be provided in these data in order to time stamp the delivery of the flow, or these data may be received by a computing device which then applies this time stamp onto the data received for certification of the delivery date.

Furthermore, the identification data in each current packet may comprise:
a total number of packets in order to deliver all said amount of energy, and
a current packet number within the total number of packets.

Therefore, this embodiment makes it possible to identify packets relating to the same delivery and their order, in order to await the receipt of any additional packets.

The method may then comprise the steps implemented by a computing device connected to the producing entity:
after a transaction with the consuming entity for an amount of energy to be delivered, retrieving at least one identifier relating to the consuming entity,
converting at least the following data:
   identifier for the consuming entity,
   the amount of energy to be delivered, and
   identifier for the producing entity,
      into a binary modulation of the power to be delivered in the additional part of the flow, and
   triggering the transmission of the flow, with said additional part so modulated, via the distribution network.

It is advantageous to use an electrical energy router to transmit the flow with said additional part to the consuming entity.

This may be a “smart” router such as the type described in WO-2014/147437.

The aforementioned computing device may be integrated into the router or directly connected to the energy meter of the producing entity.

The method may also comprise at least the following steps implemented by the consuming entity:
upon receiving the additional part of the flow, using a computing device to
   read the identification data in the additional part of the flow,
   compare the identifier for the consuming entity given in the additional part, to an identifier for the consuming entity stored in the memory,
   ignore the flow received if there is an inconsistency between the respective identifiers from the additional part and from the memory for the consuming entity,
      and, when there is consistency between said respective identifiers from the additional part and from the memory, for the consuming entity:
storing the received identification data in a memory, and
accumulating in an energy storage means (battery, inverter, or other type), for consumption, the energy of the entire flow received comprising the additional part and the main part.

In one embodiment, the method may also include at least one subsequent step implemented by the consuming entity:
at the end of receiving the flow from the producing entity, using the computing device of the consuming entity to check for conformity between the amount of energy accumulated in the aforementioned energy storage means and the amount of energy to be delivered, indicated in the data from the additional part of the flow.

This disclosure also provides a system for implementing the above method, comprising an electric power generating entity and an electric power consuming entity, and further comprising at least:
a first computing device for applying a modulation to the additional part of the flow encoding the delivery identification data, and
a second computing device for verifying the delivery identification data in said additional part of the flow and storing said data in memory.

This disclosure also concerns the first device alone in such a system. It is then configured to apply a modulation to the additional part of the flow encoding the delivery identification data.

This disclosure also concerns the second device alone in such a system, which is then configured to verify the delivery identification data in said additional part of the flow and to store said data in memory.

This disclosure also concerns a computer program comprising instructions for implementing the above method when this program is executed by a processor. FIG. 2 described below can be an example flow chart of a general algorithm for such a computer program.

The disclosure thus makes it possible to have a new DC distribution architecture capable of routing and tracing the origin of energy packets by implementing a simple data transmission protocol, and does not require any additional means other than a simple computing tool. More particularly, this computing tool is carefully programmed using a computer program to apply the aforementioned modulation and thus incorporate the data concerning the source of the energy, directly into the energy flow supplied to the consuming entity.

Therefore, the disclosure has an advantageous but non-limiting application in the context for example of supplying energy peer-to-peer on demand, with the possibility of tracing the source of this energy. So, at any time, a local producer can provide energy to a consumer who wants to consume locally and this tool allows the exchange to be tracked.

In this type of application, the disclosure proposes a reconsideration of the concept of energy distribution, labeling the source of the current for traceability, and the concept of routing these energy flows within a neighborhood, a low-voltage station, or a feeder. This will facilitate peer-to-peer exchanges between energy producing entities and consuming entities at a given moment and at an attractive cost, particularly in order to respond to the aforementioned draft ministerial ruling concerning “shared collective self-consumption”.

### BRIEF DESCRIPTION OF THE DRAWINGS

Other advantages and features of the disclosure will be evident when reading the following detailed description of some variants of the disclosure and examining the attached drawings, where:

FIG. 1 is a general diagram of a system for implementing the disclosure,

FIG. 2 illustrates the general steps of a method according to an embodiment,

FIG. 3 illustrates a first device according to an embodiment and the successive packets formed by this first device for the purposes of transmission from a producing entity, via the electricity distribution network,

FIG. 4 illustrates a second device according to an embodiment and the processing of packets received by this second device with a view to storing the energy received in an energy storage means of a consuming entity, in this case an inverter, and

FIG. 5 illustrates a particular embodiment where successive packets are transmitted via the electricity distribution network.

### DETAILED DESCRIPTION

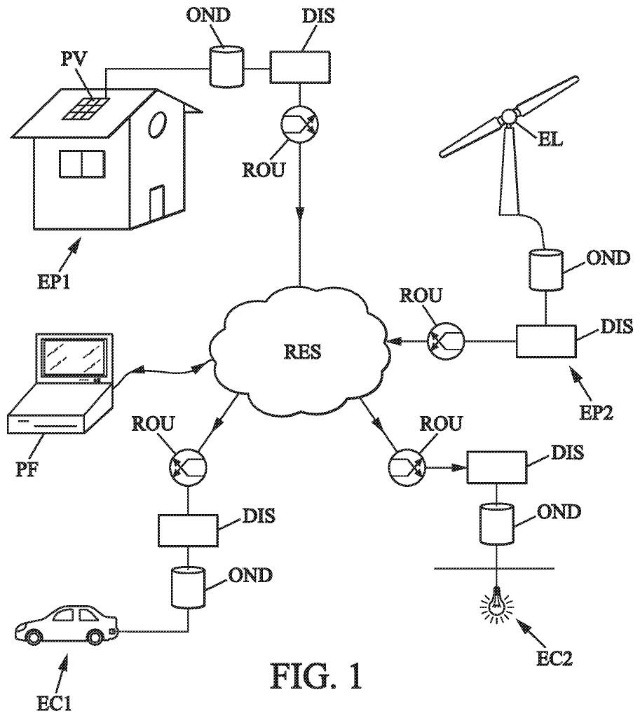

First we will refer to FIG. 1, where a producing entity (EP1) produces electrical energy, in this case by photovoltaic means PV in renewable energy production. The surplus production from this entity EP1 (relative to local consumption) can be stored in an energy storage means such as a battery or an inverter (OND), for subsequent transfer of this surplus energy to a consuming entity EC1 (for example, the charging of an electric vehicle at a third party) and/or EC2 (for example, for the electricity consumption requirements of another third party). Similarly, another producing entity, EP2, produces electrical energy by means of wind power EL and the production surplus can be stored in an energy storage means such as a battery or an inverter OND of this other producing entity EP2 for the purposes of possibly supplying third-party consumers EC1 and EC2.

So, in these exchanges and transfers of energy traveling through the electricity distribution network (RES), it is appropriate to organize these exchanges and to structure them so that the electricity distribution network is preserved. To organize these exchanges, a transaction platform PF can be provided, through which the various consuming entities EC1, EC2 can request given amounts of energy, with for example a preference concerning the nature of the production of these amounts of energy (for example, renewable or other types of energy; or energy from local production, whether neighboring or otherwise for example). For example, the platform PF may be connected by power line communication or other means (such as an Internet communication via a cellular network or the switched network) to computing devices DIS for each entity EP1, EP2, EC1, EC2 in order to organize each transaction and, in particular for:
receiving a request from a consuming entity (via its computing device DIS) for a desired amount of energy,
making a request to a producing entity (via its computing device DIS) to determine any production surplus that this producing entity is ready to release, and
if necessary, sending to the producing entity the order to release the amount of energy requested so that it is transferred to the consuming entity that is requesting it.

Once the amount of energy is delivered by the producing entity, it is transferred via the network, using the respective routers ROU of the producing entity and the consuming entity that define the inputs of the network RES. These are typically routers such as those described in document WO-2014/147437.

Hereafter, the provisions used for structuring the exchanges of electrical energy via the electricity distribution network are described in particular, followed by a particular means of implementation.

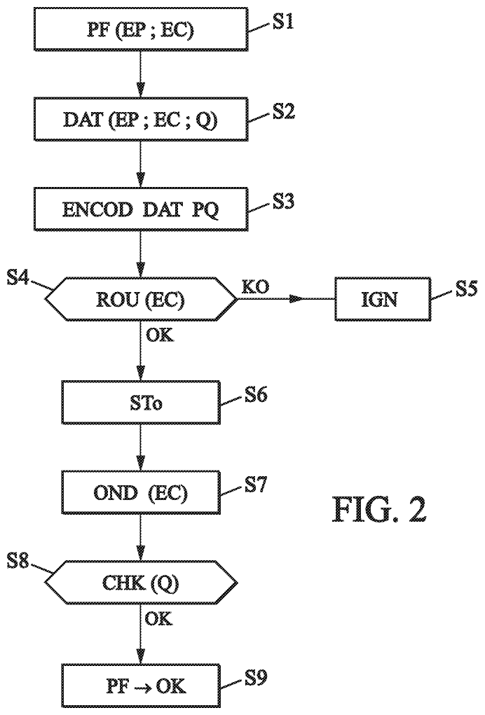

Referring now to FIG. 2, at the end of a first transaction step S1 organized by the platform PF between a producing entity EP and a consuming entity EC, the producing entity EP (or more precisely its computing device DIS) retrieves data in step S2 that are related to the transaction and typically correspond to:
an identifier for the producing entity EP,
an identifier for the consuming entity EC requesting the amount of energy (which can be received from the platform PF, for example),
the amount of energy requested,
the type of energy production (renewable or not),
and/or others.

The computing device DIS of the producing entity EP then generates a code corresponding to these data, with the aim of applying this code as a modulation of the temporal flow of power as described below.

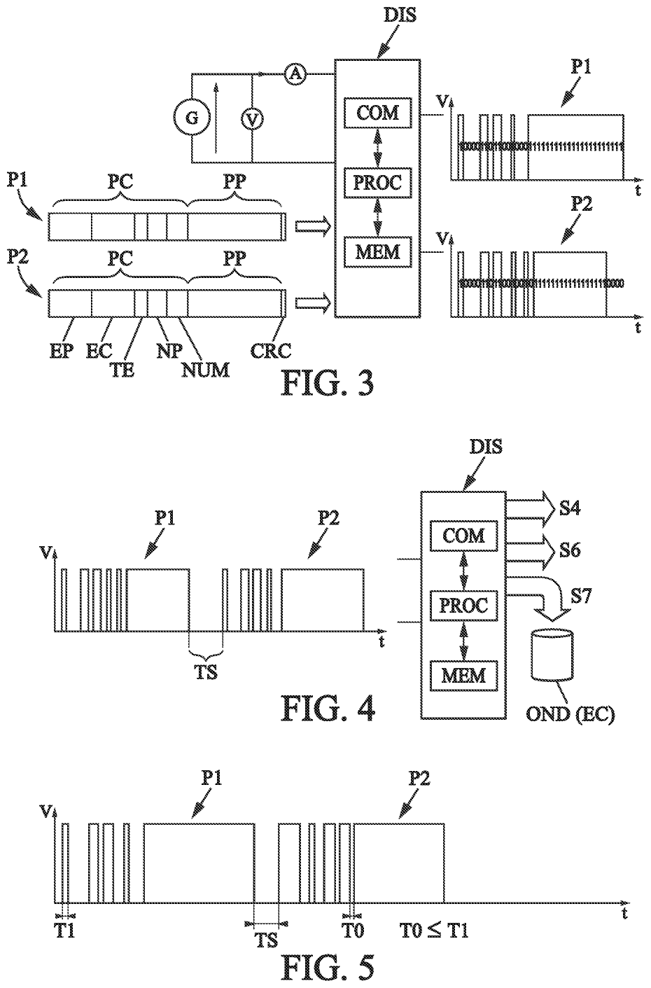

Indeed, in step S3, the producing entity delivers the requested amount of energy in the form of a temporal flow of electric power (which can correspond more precisely to a succession of packets P1, P2 as will be seen further below with reference to FIGS. 3 to 5), with, in this flow, a portion that is amplitude modulated according to the code corresponding to the above data. With reference to FIG. 3 for example, the temporal flow of packet P1 does indeed comprise a first part in which the voltage v here (in direct current DC) fluctuates in successive values of “0” or “1”, which makes it possible to encode the aforementioned data in binary. Then, the packet P1 comprises a succession of maximum voltage values (of “1”) which correspond to the amount of energy requested (or only a part of the energy requested if the energy is distributed in several successive packets).

Then, this temporal flow, possibly in the form of packets, is transmitted via the network RES by the router ROU of the producing entity. It transits from router to router in the network, according to a point-to-point mode in the example described, and, more particularly, each router that does not recognize the identifier of the associated entity (KO arrow exiting test S4) ignores this flow and transmits it to a neighboring router (step S5). However, the router ROU of the consuming entity which is declared in the encoded data at the beginning of the flow recognizes in these data the identifier of the consuming entity to which it is directly connected (OK arrow exiting test S4). This router ROU then transfers this temporal flow to an energy storage means such as a battery or inverter to which it is connected (as illustrated in FIG. 1), with a view to storing energy in this storage means in step S7, and in parallel the computing device DIS connected to this router ROU stores in memory the data presented in this flow in step S6. As an example implementation, the computing device DIS of the consuming entity may check, at the end of receiving all the flow or all the packets of the flow, (step S8) that the amount of energy received and stored for example in the inverter OND does indeed correspond to the amount of energy announced in the data encoded in the flow, and where appropriate can send in step S9 a message to the platform that the delivery of energy is in accordance with the previously initiated transaction. In this case, the method can continue with the platform organizing the billing by the producing entity to the consuming entity. For example, if the amount of energy delivered is less than what is specified in the transaction, the computing device DIS of the consuming entity can be programmed to transmit to the platform PF the amount of energy actually received from the producing entity, for the purposes of billing a smaller amount than expected. It should therefore be understood that this method, implemented essentially by computer programs installed on the devices DIS, ensures that the billing scrupulously reflects the amounts of energy actually exchanged between the parties. As such, this type of method can define a standard of energy communication between parties, particularly in the context of “shared collective self-consumption”.

With reference to FIGS. 3 to 5, an example of a form of temporal flow corresponding to the electrical energy supplied to a consumer and comprising in particular (as a stamp) identification data for this energy (in terms of the producing entity, the consuming entity, the type of production, etc.).

In the example in FIG. 3, the data that can be encoded in the flow are:
an identifier of the producing entity EP,
an identifier of the consuming entity EC (obtained from the platform PF, for example),
a type of energy production TE (renewable (“1”) or not renewable (“0”), for example),
a number of consecutive packets NP that enables transmitting the full amount of energy requested, and
a current packet number NUM among these consecutive packets (for example the fifth packet of thirteen packets total).

All these data are encoded in a first part AC of the flow, called the “additional part” above. A subsequent part PP of the flow, referred to as the “main part” above, has bits set to “1” in order to transmit as much energy as possible. Finally, at the end of the packet a few check bits CRC may be provided (as is done for frame checks in ETHERNET or other communications).

In the example shown in FIG. 3, two successive packets P1, P2 are transmitted. On the right side of FIG. 3, the beginnings of the packets are identical and declare the identifiers of the entities and the total number of packets. On the other hand, the packet index (or “current packet number” above) changes between P1 and P2. Next, there is a succession of “1”s participating in the energy delivery. One will note that in contrast, at the end of packet P2 there is a succession of “0”s which therefore indicates that the total amount of energy requested has been provided in the preceding “1”s and that only “0”s can now be used to finish the packet P2.

In practice, in the embodiment illustrated where the energies come from solar or wind power, the current is direct (DC mode) and the voltage is low voltage, for example 48 volts or more, as detailed below. In this embodiment, rather than modulating the power delivered in the temporal flow, the voltage can be modulated (simply by means of a switch function) by applying the binary values “0” or “1” corresponding to the respective levels of a zero voltage or a maximum voltage of 48V for example.

It is provided for this purpose that the computing device DIS associated with the producing entity EP performs this modulation to encode these data in binary in the voltage v, in order to deliver a corresponding power, thus modulated and sent into the network via the router ROU of the producing entity. For this purpose, the computing device DIS comprises a communication interface COM with the router ROU, as well as a processor for applying the encoding and a memory MEM storing the instructions of a computer program according to the disclosure. Working together with the memory MEM, the processor executes these instructions in order to apply the aforementioned encoding.

Moreover, the device DIS applies a synchronization duration Ts (specific to the network) between the successive packets P1, P2.

More specifically, a network control entity may define an instantiation of the packets transmitted by each producing entity (similar to a “scheduler” in the telecommunications field). This may involve, for example, the platform PF defining, after each transaction, the start times of each energy packet requested via the network. For example, the platform can define the duration of the synchronization Ts between two packets P1, P2 sent by the entity EP. Of course, each device DIS refers to the same network clock in order to transmit its packets. Alternatively, for local low voltage branches of the network (downstream of a HV/LV transformer sub-station) to which few producing entities are connected, simply the packet transmission times may be programmed for each producing entity (for example at times assigned to each entity and fixed within the day).

Reference is now made to FIG. 4 to describe the operations carried out by a computing device DIS of a consuming entity upon receiving the succession of these packets P1, P2. In the same manner, such a computing device DIS comprises a communication interface COM with the network (via the router ROU of its entity). This communication interface COM cooperates with a processor PROC that can read the instructions of a computer program according to the disclosure, stored in a memory MEM of the device. This device DIS can thus implement step S4 of reading the packet header data, ignoring these packets and simply transmitting them to the next router if they are not intended for the entity EC with which it is associated (step S5), or otherwise storing the data from the header of the packets (step S6) in a memory that may be the same as the aforementioned memory MEM (or a different memory), then instructing the router to switch the energy received in the packets towards the inverter OND of the consuming entity EC (step S7).

Now described more specifically, with reference to FIG. 5, is the form that the modulation can have in the packet header for the binary encoding of the data. Successive binary values of “0” or “1” (maximum voltage) may be observed. The duration (T0) during which the voltage value for a bit is “0” is preferably about one to a few milliseconds. These durations T0 are therefore as short as possible in order to reduce as much as possible the periods when no energy is being transmitted. On the other hand, the durations T1 when the voltage is at maximum may be greater than several milliseconds (and therefore T1>T0) in order to transmit as much energy as possible in a packet.

The following describes possible details and perspectives for the implementation of the disclosure.

For example, it is possible to rely on a plurality of energy flow routers (ROU) (of the type described in WO2014147437), located in businesses and/or homes and/or a vehicle charging station and/or within an HV/LV (for “high voltage/low voltage”) substation each having one or more DC power distribution networks (of a suitable voltage for the topologies and uses). These energy flow routers can then assume the same switching role as a router in data transmission networks, ensuring and tracking the transmission of energy packets from point A to point B.

Such an architecture makes it possible to implement the transmission of electrical energy in packets, similarly to successive frames of data.

These energy routers (ROU) can directly integrate the aforementioned computing devices DIS, so that they ROU have an artificial intelligence that can be characterized by a multi-agent system (MAS). A MAS agent is then an at least partially autonomous entity, comprising:
artificial intelligence for the decision-making aspects of the MAS agent,
distributed artificial intelligence for packet distribution and for executing instructions in the packet data,
artificial intelligence that guarantees standard packet processing from one MAS agent to another,
artificial intelligence for the knowledge of electrical objects, their energy requirements, their cycles of use,
artificial intelligence for predicting the weather and eventualities as a function of time, which updates new predictions for energy requirements, production potential, levels in storage devices,
artificial intelligence for the management of requirements and resources, which, according to the demands of the surrounding MAS agents, can communicate with the platform in order to buy or sell energy, store or not store energy, consume or not consume energy directly by the electrical devices of the entity to which this MAS agent is connected.

The platform PF itself has an artificial intelligence that enables, on request, searching for and providing the amounts of energy to buy or sell on a grid at the best price, based on the types of energy and the times of day. The platform PF is therefore a transaction agent that links the electrical equipment that wants to consume and the energy source, and keeps record of the energy exchanges for a billing agent which bills in energy units, hereinafter referred to as “WattCoins”. An analysis agent for analyzing predictions and actuals may be provided in connection with the platform, to enrich the predictions and knowledge for MAS agents.

Therefore, it is possible to provide energy flow routers placed in an eco-neighborhood, comprising an HV/LV DC electrical transformer substation, a local service platform for managing peer-to-peer energy exchanges, electrical energy storage means (inverters or other), and means of production (solar, wind, or other). Each home of this neighborhood can (and eventually will) have means for local energy production and electrical storage. So, a smart router having an agent for analyzing and creating DC energy packets in homes, charging stations, and an HV/LV substation, enables the transformation of AC and/or DC electrical energy into DC energy packets, for transmission to a consumer or for reception of these packets from a producer in order to transform them into AC and/or DC electrical energy. An advantage of this implementation is that it allows the development of new services such as energy on demand, green energy, provenance, etc.

Indeed, the transmission of energy can be carried out continuously (AC and/or DC), in which an amplitude modulation is applied in order to encode, in binary, the data to be transmitted. In direct current DC, a square signal can be generated as shown in FIGS. 3 to 5 (or any other form, of course), but at a high sampling rate (period of about a millisecond), which is like energy hashing for any voltage level (low voltage at 48V or at voltages such as 400 or 1500V).

This hashing means data can be introduced in distributed flows. In order to achieve energy exchanges between one or more producers and one or more consumers, typically the concepts of addressing, traceability, labeling, pricing (real or virtual currency, coupons etc.) are introduced, also with synchronized clocks at a neighborhood scale (for example, synchronization with the atomic clock in a transformer substation).

A digital encryption key may be provided for creating a digital certificate encoded in the header of the packets, comprising, as an example for France, an identifier of the electrical point of delivery for a home, a business, charging stations within the distribution network. This is the digital signature of the place of production or consumption. For example, this is automatically available in LINKY® type communicating meters under the name NMP (“Network Measurement Point”), when only one meter is needed to measure the consumption and production of an electrical facility, if the latter is only the surplus energy sold and not self-consumed.

For this purpose, a device DIS ensuring the analysis and creation of DC energy packets is able to create a power supply frame, based on the negotiations made for a duration such as a day by the energy exchange platform in the neighborhood (connected to an intelligent agent acting as a “trader”). The device DIS can cooperate with a DC voltage generator generating voltage of magnitude v (which for example may be 48, 400, or 1500V) as input, in order to generate as output a conventional data frame such as “Ethernet or other”, but particularly here in the form of a power supply frame intended for a consumer of the neighborhood who also has a device DIS for reading.

On the distribution network there are, therefore, energy packets continuously being transported that have multiple sources and destinations (which in this sense is similar to direct current). Each energy packet is separated by synchronization information of duration Ts. Each receiving device DIS, after detection of this synchronization, reads the header of the new packet that is traveling through, in order to determine whether or not it is the recipient. If it is the recipient, it can control the storage of the energy, but if it is not, it waits for the next synchronization.

As shown in FIGS. 3 to 5, the transmitted frame has two distinct parts, the header (identification bytes) and the body (the energy packet itself). The entirety of the composed frame is converted into energy. The logical “1”s of duration T1 correspond to the voltage level transmitted (for example, 48, 400, 1500V) and the logical “0”s of duration T0 correspond to the voltage of zero: T0 is less than or equal to T1.

There is no specific relationship between durations T0, T1 on the one hand and the synchronization period Ts on the other. The durations may be equivalent or different or may not even correspond at all if the synchronization information was, for example, a frequency or a pulse with a characteristic form in its voltage, frequency, and duration.

In contrast, on the consumer side, the agent for analyzing and creating DC energy packets of the device DIS makes it possible to determine whether the packets received come from the producer with which the consumer has made an offer to purchase via the platform, if the energy packets are indeed for it, how many packets it still has to receive, whether the energy received is of renewable origin or not, is local or not (called “green” or “red”).

The set of energy frames are then stored in an inverter, a battery, an ultra-capacitor, an electric vehicle, or other, to be converted into energy (comprising the identification bytes in order to compensate for any network losses). Next, it is possible to pull this energy from storage for the electrical uses concerned by the consumer.

Moreover, it is not always necessary to wait until all the energy packets have been received in order to start using this energy. It may be advisable, as is the case when streaming a data file, to use the inverter OND as a buffer memory, a memory that is all the more beneficial if using an “ultra-capacitor” type of technology because the charging and discharging cycles are faster and potentially more numerous.

To carry out these peer-to-peer energy exchanges, the collaborative platform (PF) which brings together the client/producer collects, for a neighborhood or for a low-voltage branch (or feeder) of the network, the energy availabilities and requirements, current pricing, and possibly the virtual exchange currency “Wattcoins”.

Depending on the energy requirements identified, a request for energy can be sent from a consuming entity to the collaborative platform for an amount Q, for and within a given time T, with the type of energy chosen. The platform selects a list of producers (in the neighborhood or upstream of the HV/LV substation) that are likely to provide this amount of energy for this length of time, as well as the various rates offered. The energy can come from one or several producers depending on the amount requested, the rate differences, the type of energy, and the number of “Wattcoins” the consumer has.

Once the requesting device has validated the transaction with the platform, the terms for the quantity, time, cost, and energy type, the platform directly links the devices of the producer and consumer, and if necessary the HV/LV substation for the switching, by transmitting the respective address identifiers to each of them.

The consumer device can submit its request to the producer(s) selected for its request for an amount (Q) of energy, possibly renewable, according to the pricing and the time requested. The device of the producer or producers generates energy packets that will be received by the device of the consumer.

Once the number of energy packets has been received, as an example, a frame for an exchange between consumer and producers and/or between consumer, trading platform, and producers, may be provided as notification to pay the number of “Wattcoins” provided, by means of a billing agent connected to the platform for example (or in the form of a computer module stored in each device DIS). The sale makes it possible to obtain Wattcoins which in turn make it possible to buy energy or electricity usage time or recharging for an electric vehicle in the neighborhood.

Such an embodiment allows tracked peer-to-peer exchanges of energy between producers and consumers in a same LV feeder, in a private area at the scale of a neighborhood, of a low voltage substation (LV), or of an LV outgoing line, or within a building, housing between two facilities, guaranteeing the provenance of the production of electric current (green energy or not, local within the eco-neighborhood, or national, etc.).

The energy flow routers can then assume the same switching role as a router in data transmission networks, ensuring and tracking the transmission of energy packets from point A to point B, as with communications within a telecommunications network.

1. A method for delivering an amount of electrical energy between an energy producing entity and an energy consuming entity, with this amount of energy being delivered via an electricity distribution network in the form of at least one temporal flow of electric power, at a constant level on at least a main part of the flow, wherein, in order to identify the delivery via the network, the flow further comprises an additional part including delivery identification data, the electric power being modulated in amplitude in the additional part, the additional part therefore having periods when the electric power is lower than said constant level of the main part of the flow.

2. The method according to claim 1, wherein, the amount of energy being delivered as direct current, said additional part of the flow comprises periods when the electric voltage of the flow is zero, the modulation being applied to the voltage in order to encode the delivery identification data into two binary values corresponding to a zero voltage and a maximum voltage, this maximum voltage corresponding to said constant level of power of said main part of the flow.

3. The method according to claim 1, wherein the energy delivery is carried out by a transmission of a plurality of successive packets of temporal flows each comprising a main part of the flow and an additional part including delivery identification data, the additional part of the flow preceding the main part of the flow in each packet.

4. The method according to claim 3, wherein the packets are spaced apart in time by a chosen duration of synchronization of the distribution network.

5. The method according to claim 1, wherein the identification data comprise:
an identifier relating to the producing entity,
an identifier relating to the consuming entity,
an amount of energy to deliver.

6. The method according to claim 5, wherein the identification data further comprise:
a type of electrical energy produced at least according to renewable energy production channels, or according to other channels.

7. The method according to claim 3, wherein the packets are spaced apart in time by a chosen duration of synchronization of the distribution network and wherein the identification data in each current packet further comprise:
the total number of packets to deliver all said amount of energy, and
a current packet number within the total number of packets.

8. The method according to claim 1, comprising the steps implemented by a computing device connected to the producing entity:
after a transaction with the consuming entity for an amount of energy to be delivered, retrieving at least one identifier relating to the consuming entity,
converting at least the following data:
identifier for the consuming entity,
the amount of energy to be delivered, and
identifier for the producing entity,
into a binary modulation of the power to be delivered in the additional part of the flow, and
triggering the transmission of the flow, with said additional part so modulated, via the distribution network.

9. The method according to claim 8, wherein an electrical energy router is used to transmit the flow, with said additional part, to the consuming entity.

10. The method according to claim 8, comprising the following steps implemented by the consuming entity:
upon receiving the additional part of the flow, using a computing device to
read the identification data in the additional part of the flow,
compare the identifier for the consuming entity given in the additional part, to an identifier for the consuming entity stored in the memory,
ignore the flow received if there is an inconsistency between the respective identifiers from the additional part and from the memory, for the consuming entity,
and, when there is consistency between said respective identifiers from the additional part and from the memory, for the consuming entity:
storing the received identification data in a memory, and
accumulating in an energy storage means, for consumption, the energy of the entire flow received comprising the additional part and the main part.

11. The method according to claim 10, further comprising the consuming entity:
at the end of receiving the flow from the producing entity, using the computing device of the consuming entity to check for conformity between the amount of energy accumulated in the energy storage means and the amount of energy to be delivered, indicated in the data from the additional part of the flow.

12. A system for implementing the method according to claim 1, comprising an electric power generating entity and an electric power consuming entity, further comprising:
a first computing device for applying a modulation to the additional part of the flow encoding the delivery identification data, and
a second computing device for verifying the delivery identification data in said additional part of the flow and storing said data in memory.

13. A first device of the system according to claim 12, wherein it is configured to apply a modulation to the additional part of the flow encoding the delivery identification data.

14. A second device of the system according to claim 12, wherein it is configured to verify the delivery identification data in said additional part of the flow and to store said data in memory.

15. A non-transitory computer-readable medium having stored thereon computer-executable instructions for implementing the method according to claim 1, when executed by a processor.

16. The method according to claim 3,
wherein the identification data comprise:
an identifier relating to the producing entity,
an identifier relating to the consuming entity,
an amount of energy to deliver, and
wherein the identification data in each current packet further comprise:
the total number of packets to deliver all said amount of energy, and
a current packet number within the total number of packets.
